(19) United States
(12) Patent Application Publication
(10) Pub. No.: US 2026/0243705 A1
(43) Pub. Date: Aug. 20, 2026

(54) CALIBRATION SYSTEM AND METHOD FOR RADIATION IMAGING SYSTEM

(71) Applicant: VAREX IMAGING CORPORATION, Salt Lake City, UT (US)

(72) Inventors: Gongyin Chen, Las Vegas, NV (US); Maria Sarkisian, Wilmette, IL (US); Robert C. Gemperline, Algonquin, IL (US); Ryan Bradford, Chicago, IL (US); David Janes, Rolling Meadows, IL (US)

(21) Appl. No.: 19/421,286

(22) Filed: Dec. 16, 2025

Related U.S. Application Data
(60) Provisional application No. 63/759,293, filed on Feb. 17, 2025.

(51) Int. Cl. G01N 23/04; G01N 23/083

(52) U.S. Cl. CPC G01N 23/04; G01N 23/083; G01N 2223/303; G01N 2223/408

(57) ABSTRACT

Radiation imaging systems and methods and systems and methods for calibrating the same are disclosed. A non-transitory computer-readable medium storing code for calibrating a radiation imaging system is disclosed. The code can include instructions executable by a processor to receive a data stream from a radiation detector and assign a material category to a pixel based on the data stream and a plurality of calibration parameters. The material category can be selected from a plurality of material categories. The plurality of calibration parameters can include adjustable boundaries between the material categories of the plurality of material categories.

### CROSS-REFERENCE TO RELATED APPLICATIONS

This application claims priority to U.S. patent application No. 63/759,293, filed 17 Feb. 2025, the entire disclosure of which is hereby incorporated by reference.

### FIELD

The described embodiments relate generally to systems and methods for scanning objects with radiation, and more particularly, to systems and methods for calibrating systems for scanning objects with radiation.

### BACKGROUND

X-ray imaging (e.g., projection radiography) is widely used for scanning internal structures of objects. In a medical setting, this can be used to create images of a body's internal structures, while in an industrial setting, this can be used to image internal structures in baggage, cars, cargo, other containers and objects, and the like. A system for performing x-ray imaging can include an x-ray source that produces x-rays, which are collimated towards a scanned object. A detector array can record attenuated x-rays that pass through the scanned object. The extent of attenuation along each beam path of the x-rays that pass through the scanned object can depend on the amount of material the x-ray passes through and the type of material the x-ray passes through.

Dual-energy radiography can use an x-ray source that produces alternating higher-energy (HE) and lower-energy (LE) x-rays. In other words, a scanned object can be imaged twice, once with HE x-ray beams and once with LE x-ray beams. This can be used to produce two sets of attenuation data for the scanned object: HE attenuation data and LE attenuation data. Differences between the HE attenuation data and the LE attenuation data can be used to extract information about the types of material in the scanned object. The attenuation data can further be used to extract information about the thickness of material in the scanned object.

Radiation imaging systems can be used to produce images, graphs, and other data that reflect what materials are present, where the materials are located, and thicknesses of the materials in a scanned object. The materials in a scanned object can be divided into material categories. A calibration process can be performed on a radiation imaging system in order to determine various parameters for the radiation imaging system, such as material discrimination lines used to separate the materials into different material categories.

### SUMMARY

An aspect of the present disclosure relates to a non-transitory computer-readable medium storing code for calibration of a radiation imaging system, the code including instructions executable by a processor to receive a data stream from a radiation detector and assign a material category to a pixel based on the data stream and a plurality of calibration parameters. The material category can be selected from a plurality of material categories. The plurality of calibration parameters can include adjustable boundaries between the material categories of the plurality of material categories.

In one or all examples, each of the adjustable boundaries can include a single value above which the pixel is assigned to a first material category and below which the pixel is assigned to a second material category. In one or all examples, each of the adjustable boundaries can include a range of values above which the pixel is assigned to a first material category, below which the pixel is assigned to a second material category, and between which the pixel is assigned to a mixed material category or a null material category. In one or all examples, the code can further include instructions executable by the processor to display an image including the pixel. The pixel can be displayed with a first color when the pixel is assigned to the first material category, a second color when the pixel is assigned to the second material category, or a third color including a combination of the first color and the second color when the pixel is assigned to the mixed material category.

In one or all examples, the plurality of calibration parameters can further include a user adjustable thickness range for each material category within which the material category is assigned to the pixel and outside of which no material category is assigned to the pixel. In one or all examples, each of the adjustable boundaries can be adjustable at a plurality of thickness locations.

In one or all examples, the plurality of calibration parameters can further include an adjustable beam angle compensation parameter configured to compensate for a position of the pixel in the radiation detector relative to an incident x-ray beam.

In one or all examples, the code can further include instructions executable by the processor to select a region of interest from the data stream, the region of interest corresponding to a set of pixels of the radiation detector, and to assign material categories to each pixel in the region of interest based on the data stream and the plurality of calibration parameters. In one or all examples, the code can further include instructions executable by the processor to use machine learning to propose values for the adjustable boundaries.

Another aspect of the present disclosure relates to a method of calibrating a radiation imaging system, the method including receiving attenuation data from a radiation detector, the attenuation data including attenuated x-ray radiation detected at each pixel of a plurality of pixels in the radiation detector, determining a material signature for each pixel of the plurality of pixels based on the attenuation data, determining a material category for each pixel of the plurality of pixels based on the material signatures and a plurality of calibration parameters, the plurality of calibration parameters including a dividing line value between material categories, updating the plurality of calibration parameters in response to a user adjusting the dividing line value, and re-determining the material category for each pixel of the plurality of pixels based on the material signatures and the updated plurality of calibration parameters.

In one or all examples, receiving the attenuation data can include receiving first attenuation data corresponding to a first scan at a first x-ray energy level and receiving second attenuation data corresponding to a second scan at a second x-ray energy level different from the first x-ray energy level. In one or all examples, the material signature for each pixel can be based on a difference between the first attenuation data and the second attenuation data corresponding to the respective pixel. In one or all examples, the method can further include determining a material thickness for each pixel of the plurality of pixels based on the attenuation data. The material thickness for each pixel can be based on either the first attenuation data or the second attenuation data corresponding to the respective pixel.

In one or all examples, the method can further include saving the updated plurality of calibration parameters in a memory and performing a material discrimination process on an object based on the updated plurality of calibration parameters saved in the memory.

In one or all examples, the plurality of calibration parameters can further include a beam angle compensation value. The beam angle compensation value can vary the determination of the material category for each pixel of the plurality of pixels based on a relative location of the respective pixel in the radiation detector.

Yet another aspect of the present disclosure relates to a radiation imaging system including an x-ray detector, a processing device coupled to the x-ray detector, the processing device configured to process attenuation data from the x-ray detector and generate a user interface. The user interface can be configured to present a material discrimination display based on the attenuation data, receive user instructions to update calibration parameters, and update the material discrimination display in real-time based on the updated calibration parameters.

In one or all examples, the calibration parameters can include adjustable hues associated with each of a plurality of material categories and the material discrimination display can assign one of the plurality of material categories to each of a plurality of pixels.

In one or all examples, the attenuation data can include a beam angle for each of a plurality of pixels of the x-ray detector and the material discrimination display can assign one of a plurality of material categories to each of the plurality of pixels based on the respective beam angle.

In one or all examples, the calibration parameters can include user-adjustable values that separate the attenuation data into a plurality of material categories. In one or all examples, the user interface can be further configured to present the material discrimination display based on a user-adjustable region of interest.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a schematic view of a radiation imaging system.

FIG. 2A illustrates an image of a scanned object produced by a radiation imaging system.

FIG. 2B illustrates a material discrimination graph of the scanned object produced by the radiation imaging system of FIG. 2A.

FIG. 3 illustrates a block diagram of a method of calibrating material discrimination parameters for a radiation imaging system.

FIG. 4 illustrates a block diagram of a computing device that supports techniques for calibrating a radiation imaging system.

### DETAILED DESCRIPTION

Reference will now be made in detail to representative embodiments illustrated in the accompanying drawings. The following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to radiation imaging systems and methods that can be used to scan or inspect internal structures of objects. Radiation imaging systems and methods can be used for imaging in a variety of contexts, including medical imaging, diagnostics, non-destructive testing, materials detection or analysis, security inspection, and the like. In a medical setting, radiation imaging systems and methods can be used to create images of a body's internal structures. In an industrial setting, radiation imaging systems and methods can be used to image internal structures in baggage, cars, cargo, other containers and objects, and the like.

More specifically, the following disclosure relates to systems and methods for calibrating radiation imaging systems. To calibrate a radiation imaging system, the radiation imaging system can be used to scan an object. The radiation imaging system can be a dual-energy radiation imaging system, which scans the object alternately with higher-energy (HE) x-ray beams and lower-energy (LE) x-ray beams. A radiation detector can receive the attenuated x-ray beams after the x-ray beams pass through the object and attenuation data is produced based on the attenuated x-ray beams (e.g., HE attenuation data and LE attenuation data). The attenuation data can be used to derive material signatures and material thicknesses for a plurality of pixels or data points, which represent and can be correlated to areas in the scanned object. The material signatures and material thicknesses can be used to determine what types of materials are present in the scanned object (e.g., which material category is assigned to each pixel or data points), thicknesses of materials in the scanned object, and the like. The following disclosure provides a material discrimination calibration process that utilizes scans or images of known objects to determine accurate thresholds or dividing lines to differentiate the pixels or data points into discrete material categories. Such dividing line values and other calibration parameters can be adjusted and saved and can be applied to future scans or imaging to produce improved and accurate material discrimination results.

The radiation imaging system can perform a material discrimination in which the radiation imaging system assigns a material category and a material thickness to a plurality of pixels, which correlate to areas of the scanned object. The radiation imaging system can assign the material categories and thicknesses based on calibration parameters. The following disclosure describes systems and methods for determining and adjusting the calibration parameters that are used for the radiation imaging system.

In the present disclosure, a known object can be scanned with a radiation imaging system. The radiation imaging system can display a material discrimination graph and a full image to a user based on attenuated x-rays detected by a radiation detector of the radiation imaging system. The material discrimination graph can include a plot of pixel dots or data points corresponding to areas of the known object with axes of material signature vs. material thickness. The full image (e.g., also referred to as a phantom image) can be a greyscale image of the scanned object 102 produced by comparing the signal received by the radiation detectors 108 with no scanned object 102 present (e.g., signalₐᵢᵣ) with the signal received by the radiation detectors 108 with the scanned object 102 present (e.g., signal_{object}). The full image can illustrate the difference between material portions of the scanned object 102 and air around the scanned object 102.

Based on information of the known scanned object for material calibration a user of the radiation imaging system can associate clusters of the pixel dots with material types. The user can then adjust calibration parameters, including dividing lines that will be used in material determination, to generate a material discrimination image. The material discrimination image can include a color overlay on the full image that represents material categories with colors and material thicknesses with shades of the colors. The material discrimination image and graph presented to the user can be updated in real time (e.g., as changes are made to the calibration parameters). This allows the user to adjust the calibration parameters to obtain a material discrimination image and graph that are aligned with a known object, which is scanned. Allowing a user to determine and adjust the calibration parameters can speed up the calibration process, improve the accuracy of the calibration parameters and subsequent scans using the calibration parameters, and the like. Moreover, the user may be able to adjust various display parameters for the material discrimination image and graph, which can improve the readability and aesthetics of the material discrimination image and graph.

Experimental data, specifically pixel-by-pixel material signature and thickness data obtained from the scans of known objects, can be presented to a user, who can vary various calibration parameters, including dividing lines separating material categories. The experimental data can include HE attenuation data, LE attenuation data, and the like. The experimental data can be processed to provide pixel by pixel material signature and thickness data, which can be plotted in the material discrimination graph. The material pixel by pixel material signature and thickness data can be plotted in the graph as clusters of dots. This material signature and thickness data can be combined with information about types of materials present in the scanned object (e.g., the type of material that each cluster of dots corresponds to) to facilitate the user in drawing material discrimination dividing lines between material categories. The calibration parameters can include threshold values used to separate types of materials present in the scanned object into different material categories.

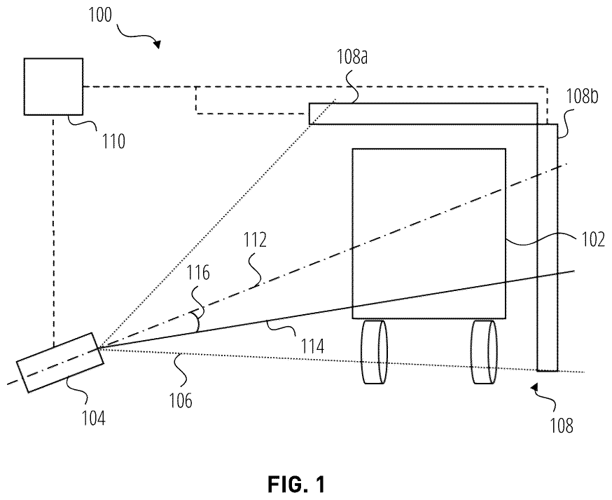

These and other examples are discussed below with reference to FIGS. 1 through 4. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 is a schematic view of a radiation imaging system 100. The radiation imaging system 100 can be used to analyze internal structures in a scanned object 102. The radiation imaging system 100 includes a radiation source 104 that produces a radiation beam 106 (e.g., x-rays) directed towards a scanned object 102 and radiation detectors 108. The x-rays of the radiation beam 106 are attenuated as they pass through the scanned object 102. The radiation detectors 108 detect attenuated x-rays that pass through the scanned object 102. The attenuated x-rays detected by the radiation detectors 108 can be used to determine various characteristics of the scanned object 102, such as what materials or types of materials are present in the scanned object 102, thicknesses of materials in the scanned object 102, and the like. The radiation imaging system 100 can be used in a variety of contexts, including medical imaging, diagnostics, non-destructive testing, materials detection or analysis, security inspection, and the like. The scanned object 102 can be baggage, a vehicle, cargo, freight, a body or a portion thereof, or any other object.

The radiation source 104 can include an x-ray source, such as an-x-ray source based on a linear accelerator. The radiation source 104 can produce x-rays and accelerate the x-rays towards the scanned object 102 and the radiation detectors 108. The radiation source 104 can be a dual-energy x-ray source, which can produce alternating higher energy (HE) and lower energy (LE) x-rays. In other words, the scanned object 102 can be imaged twice: once with HE x-rays and once with LE x-rays. This can produce two sets of attenuation data when the HE x-rays and the LE x-rays are detected by the radiation detectors 108, referred to as HE attenuation data and LE attenuation data. The difference between the HE attenuation data and the LE attenuation data can be used to extract a material signature. The material signature can be used to determine the type of material along an x-ray beam path. The HE attenuation data (e.g., a log 10 of the HE attenuation data) can be used to approximate the thickness of material along an x-ray beam path. The material signature can vary with the thickness of material disposed along an x-ray beam path. The material signature and the material thickness can be approximated or determined based on any suitable characteristics. For example, the material signature can be based on a ratio between the HE attenuation data and the LE attenuation data, a ratio between log 10 of the HE attenuation data and log 10 of the LE attenuation data, a ratio between a natural log of the HE attenuation data and a natural log of the LE attenuation data, or the like. The material thickness can be based on the HE attenuation data or the LE attenuation data, a log 10 of the HE attenuation data or the LE attenuation data, a natural log of the HE attenuation data or the LE attenuation data, or the like. Other data, calculations, or approximations can be used to determine the material signature and material thickness of a material disposed along an x-ray beam path.

The radiation source 104 can produce x-rays having energies in the keV range, in the MeV range, or the like. For example, the radiation source 104 can produce HE x-rays having energies of about 6 MeV and LE x-rays having energies of about 4 or about 3.8 MeV, the HE x-rays, and the LE x-rays can have energies in a range from about 100 keV to about 500 keV, or the like. The beam energies produced by the radiation source 104 can depend on the context in which the radiation imaging system 100 is used. For example, beam energies in the MeV range can be used for cargo scanning, while beam energies in the keV range can be used for baggage scanning, vehicle scanning, and the like.

The radiation detectors 108 record attenuated x-rays for each beam path of the radiation beam 106 after the x-rays pass through the scanned object 102. In other words, the radiation detectors 108 records remaining x-rays of each beam path after passing through the scanned object 102. The radiation detectors 108 can each include a one-dimensional array, or can include multiple columns, and multiple columns or relative motion between the radiation imaging system 100 and the scanned object 102 can be used to produce two-dimensional attenuation data for the scanned object 102. In the example of FIG. 1, the radiation detectors 108 are illustrated as including two radiation detector segments: a horizontal radiation detector segment 108a and a vertical radiation detector segment 108b. A typical cargo imaging system may contain several hundred or over a thousand detector elements (pixels), which can be included in any number of radiation detector segments. Thus, the radiation imaging system 100 can include any number of radiation detector segments. The resulting two-dimensional attenuation data is essentially a map of attenuation through the scanned object 102. The extent of attenuation along each beam path through the scanned object 102 can be represented as a single pixel or data point in the attenuation data and is dependent on: (1) the amount of material the x-rays pass through and (2) the type of material the x-rays pass through.

The radiation detectors 108 can include a plurality of pixels. X-ray attenuation data can be produced by each pixel of the radiation detectors 108 in response to attenuated x-rays received at each respective pixel. Each data point in the x-ray attenuation data can be produced by a pixel of the radiation detectors 108, can include HE attenuation data and LE attenuation data, and can correspond to a discrete area of the scanned object 102. Each data point can be used to determine a material signature and a material thickness for a portion of the scanned object 102. The material signatures can be representative of types of materials present in the scanned object 102. The material types can be dividing into various material categories. For example, in a baggage scan, the material types can be divided into three categories: light materials or organic materials having atomic numbers (alternatively referred to as Z-values) less than 10; intermediate materials or inorganic materials having atomic numbers between 10 and 20; and metallic materials having atomic numbers over 20. In a cargo scan, the material types can be divided into four categories: light materials or organic materials having atomic numbers less than 10; intermediate materials or inorganic materials having atomic numbers between 10 and 20; metallic materials having atomic numbers between 20 and 50, and heavy metals having atomic numbers greater than 50.

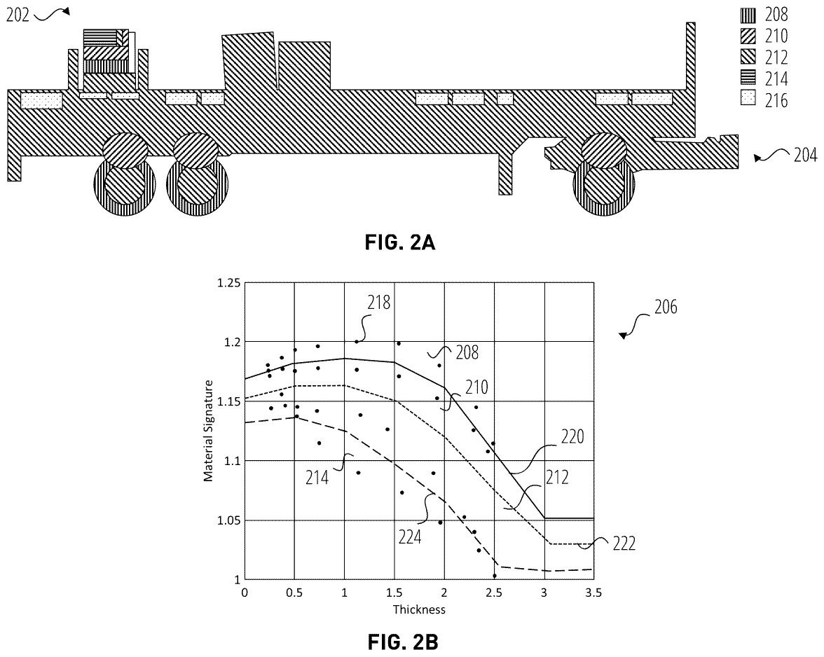

The radiation imaging system 100 can include a computing device 110, which can be coupled to the radiation source 104 and/or the radiation detectors 108. In one or all examples, the computing device 110 can control various functions of the radiation source 104 and/or the radiation detectors 108, such as controlling generation and timing of the x-rays by the radiation source 104, controlling capture of the attenuation data by the radiation detectors 108, and the like. The computing device 110 can receive the attenuation data generated by the radiation detectors 108 and present the data to users through a display or the like. For example, as will be discussed in detail with respect to FIGS. 2A and 2B, the computing device 110 can be used to display a material discrimination image and a material discrimination graph based on the attenuation data generated by the radiation detectors 108.

Based on the attenuation data generated from a scan of the scanned object 102, the computing device 110 can assign a material category and a thickness to each data point or pixel of the attenuation data. Known objects can be scanned by the radiation imaging system 100 and can be used to calibrate material discrimination parameters of the radiation imaging system 100 to ensure that the radiation imaging system 100 makes correct determinations of material categories, thicknesses, and the like. For example, the radiation imaging system 100 can be used to scan a scanned object 102. Material signatures and thicknesses for a plurality of pixels can be presented to a user. The user can identify what material type each of a plurality of clusters of pixels illustrated in the graph correspond to in order to determine various calibration parameters for the material discrimination, including dividing lines between material categories. This can ensure that material categories, thicknesses, and the like proposed by the radiation imaging system 100 match material categories, thicknesses, and the like present in the scanned object 102.

The user can adjust various calibration parameters, including dividing lines between material categories, which can then be used in subsequent scans. After a scan is performed, material signature and material thickness for each data point or pixel can be shown in the material discrimination graph. The data points or pixels may group together in clusters depending on the materials present in the scanned object 102. For purposes of a material discrimination calibration, the scanned object 102 can be a known object. Since a known object is scanned, a user may know a material type or category for materials present in the scanned object 102, and the user can identify a material type for each of the clusters of data points or pixels. The user can then select, adjust, or vary dividing lines between the material categories so that the data points or pixels (e.g., and clusters) are assigned to the correct material categories.

The material signature can be calculated from differences between the HE attenuation data and the LE attenuation data. In one or all examples, the differences between the HE attenuation data and the LE attenuation data can be used to calculate a K value for each data point or pixel of the attenuation data according to the following equation:

$$Log 10 ( {LE}_{attenuation} ) / Log 10 ( {HE}_{attenuation} ) = {μ}_{LE} / {μ}_{HE} = K$$

Thus, the K value can represent a ratio of a measured x-ray attenuation coefficient with HE x-rays relative to LE x-rays. The material signature can be calculated pixel-by-pixel. In one or all examples, raw HE attenuation data and LE attenuation data (e.g., without a log 10 calculation), natural log HE attenuation data and LE attenuation data, or other HE attenuation data and LE attenuation data can be used to determine the material signature of each pixel or data point. The HE attenuation data and the LE attenuation data can be produced by comparing the signal received by the radiation detectors 108 with no scanned object 102 present (e.g., signalₐᵢᵣ) with the signal received by the radiation detectors 108 with the scanned object 102 present (e.g., signal_{object}).

The material thickness can be calculated, for example, based on the HE attenuation data or the LE attenuation data. For example, the material thickness can be approximated by log 10 of the HE attenuation data. In one or all examples, the material thickness can be approximated by the HE attenuation data, the LE attenuation data, log 10 of the HE attenuation data, a natural log of the HE attenuation data, log 10 of the LE attenuation data, a natural log of the LE attenuation data, or the like.

The dividing lines between the material categories can be assigned specific values by the user, guided by the clusters of data points or pixels and known material types or categories for each cluster of pixels. For example, a data point or pixel with a K-value greater than a dividing line can be assigned to one material category, while a data point or pixel with a K-value less than the dividing line can be assigned to another material category. In one or all examples, a small region above and below the dividing lines may be treated as a low confidence region for material discrimination, and either marked as no material determination (e.g., displayed in a material discrimination image in a neutral color, such as grey) or market as an intermediate material category (e.g., displayed in the material discrimination image in a color hue between those for the neighboring material categories). The K-value is one example of a parameter that can be used to represent a material signature; however, any suitable parameter can be used to represent the material signature.

The user can select, adjust, or vary the dividing lines between the material categories independently at various material thicknesses. For example, the user can adjust the K-values for dividing lines between the material categories at eight thickness points, although the dividing lines can be varied at more than or less than eight thickness points. The user can also adjust additional calibration parameters, such as a de-noising filter size and/or type (used to filter the HE attenuation data and/or the LE attenuation data), colorization parameters (used to adjust a material discrimination image presented to the user), and the like. The radiation imaging system 100 can be more accurate within certain thickness ranges for each material category, and the calibration parameters can include adjustable thickness ranges for each of the material categories. For each material category, a material category can be assigned to a pixel when the material thickness for the pixel is within the adjustable thickness range and no material determination category, a null material category, or an “other” material category can be assigned to the pixel when the material thickness is outside the adjustable thickness range. Each of the calibration parameters can be saved and applied to future scans performed by the radiation imaging system 100.

In one or all examples, the calibration parameters can include a beam angle compensation (BAC) parameter. As illustrated in FIG. 1, the radiation beam 106 can be a fanned beam with a beam centerline 112. Energy of x-rays in the radiation beam 106 can decrease as an angle between the respective x-ray and the beam centerline 112 increases. For example, an angled beam 114 that is angled at an angle 116 relative to the beam centerline 112 can have a reduced energy as compared to an x-ray beam at the beam centerline 112. The beam angle compensation parameter can be a single value that is used to compensate for this variation in energy of the radiation beam 106. The beam angle compensation parameter can be used to alter the dividing lines between the material categories and can be done used at one or more thickness points. The beam angle compensation parameter can be defined as a relative reduction in material signature between the beam centerline 112 and a reference angle, such as an angle of about 30. Dividing line K-values can be adjusted at various beam angles in order to compensate for material signature variation relative to beam angle in experimental data (e.g., variation in material signature of pixels disposed at various locations). For example, the beam angle compensation parameter can be calculated according to the following equation:

$$BAC = 1 - \frac{{K}_{reference angle} - 0.99}{{K}_{centerline} - 0.99}$$

The effect of the beam angle compensation parameter can be prorated at other beam angles, and can use an absolute angle such that plus and minus angles are treated the same. For example, the beam angle compensation parameter can be calculated at any angle according to the equation:

$${BAC}_{angle} = BAC * \frac{\vert angle \vert}{reference} angle = 1 - \frac{{K}_{angle} - 0.99}{{K}_{centerline} - 0.99}$$

The beam angle compensation parameter can be used to adjust the dividing line K-values at each thickness point according to the equation:

$${K}_{angle} - 0.99 = ( {K}_{calibration angle} - 0.99 ) * ( 1 - BAC * ( \vert angle \vert / reference angle ) / ( 1 - BAC * ( \vert calibration angle \vert / reference angle )$$

Using a single value for beam angle compensation allows for a user to quickly and easily adjust how the radiation imaging system 100 accounts for energy loss due to a data point or pixel being detected at a point outside of the beam centerline 112. Although the beam angle compensation parameter has been described in the context of a linear model, other models, such as a quadratic model or the like, can be used for the beam angle compensation parameter. As such, in one or all examples, the multiple individual parameters can be adjusted to adjust the beam angle compensation parameter. The beam angle compensation parameter can be used to compensate for energy variation based on positions of pixels relative to the radiation beam 106.

The user can iteratively adjust each of the calibration parameters. For example, the computing device 110 can present the user with a display that illustrates a material discrimination image and/or a material discrimination graph. Initial material categories can be set for each data point or pixel based on default or previously set calibration parameters. The computing device 110 can allow for the user to adjust each of the calibration parameters. After the user makes an adjustment to the calibration parameters, the adjusted calibration parameters can be saved and an updated material discrimination image and/or material discrimination graph can be presented to the user. This allows the user to see how their changes to the calibration parameters effect the material discrimination image, the material discrimination graph, and the material categories that are assigned to the data points or pixels and aids the user in selecting calibration parameters that correctly describe the scanned object 102. This allows users to set calibration parameters more quickly and for the user to set more accurate calibration parameters, which improves the accuracy of subsequent scans by the radiation imaging system 100 using the calibration parameters.

The computing device 110 can further allow the user to select or set demilitarization zones (DMZs). The DMZs can be set along dividing lines between materials of different material categories. The user can set DMZs as bands along dividing lines in which no material determinations are made. This can prevent incorrect material determinations from being made based on areas that are on the border between material categories.

The user can further make various selections that impact what areas of information are presented to the user. For example, the user can select a region of interest from the full image. Material signatures and thicknesses of pixels within the ROI can be presented in the material discrimination graph, while material signatures and thicknesses of pixels outside the ROI are omitted from the material discrimination graph. This can make the task of a user identifying material types of clusters of pixels in the material discrimination graph easier. A user can select the ROI to include specific areas of the full image that include blocks of known materials with various thicknesses. The blocks and corresponding clusters of pixels can include or provide sufficient information for a user to draw dividing lines between material categories at various thickness points. In one or all examples, the user can select the ROI to include a single material type (e.g., one category), which can further aid in easily identifying material categories of the clusters of pixels in the material discrimination graph. Known materials including known blocks of materials can be referred to as material discrimination calibration phantoms. In some cases, material discrimination calibration phantoms may not be available. However, even in these cases, other known objects can be scanned, a user can select ROIs (e.g., including one or more material categories), the user can correlate material categories with clusters of pixels, and the user can adjust dividing lines between the material categories.

The computing device 110 can further display information that can aid the user in adjusting the calibration parameters. For example, the computing device 110 can track the user's mouse or other cursor. Based on the position of the user's cursor on a full image, an ROI image, or a material discrimination image of the scanned object 102, the computing device 110 can display or highlight a pixel, a material signature, and a material thickness in the material discrimination graph.

The calibration system and method used by the computing device 110 can adjust how calibration parameters for the radiation imaging system 100 are determined. For example, the calibration system and method used by the computing device 110 can allow the user to manually adjust the calibration parameters in order to achieve a desired calibration, which can be illustrated by the material discrimination image and the material discrimination graph. Material signatures and thicknesses from the scan of the scanned object 102 can be presented to the user and the user can adjust the calibration parameters based on these material signatures and thicknesses. This can provide more accurate calibration parameters, which can be saved, used in subsequent scans by the radiation imaging system 100, and can result in a more accurate system. The calibration system and method used by the computing device 110 is an iterative method, which allows for the user to see the results of changes in the calibration parameters in real time and adjust the calibration parameters accordingly. The computing device 110 can perform bookkeeping and tracking processes, while the user adjusts the calibration parameters.

The computing device 110 can include a display, an image processor, a computer, one or more memory devices, one or more input devices, and the like. The computing device 110 may be an example of or include the components of a computer, a computing device, a computing system, or another electronic device. The computing device 110 may be an example of a portable electronic device, a computer, a laptop computer, a tablet computer, a smartphone, a cellular phone, a wearable device, an internet-connected device, a server, a database, or the like.

FIGS. 2A and 2B illustrate portions of a display that can be displayed to a user while calibrating a radiation imaging system to perform material discrimination. FIG. 2A illustrates an image 202 of a scanned object 204 that can be presented to the user. FIG. 2B illustrates a material discrimination graph 206, which can plot material signatures and thicknesses of pixels 218. The image 202 illustrated in FIG. 2A can be used by the user to select, accept, and manage regions of interest (ROIs), which can alter the pixels 218 displayed in the material discrimination graph 206. Once material discrimination results become available, a material discrimination overlay can be presented on the image 202 of FIG. 2A. The radiation imaging system used to produce the material discrimination image 202 and the material discrimination graph 206 can be the same as or similar to the radiation imaging system 100, discussed above with respect to FIG. 1.

FIG. 2A illustrates the image 202 with an overlay that includes a first material 208, a second material 210, a third material 212, a fourth material 214, and an undetermined material 216. When a material discrimination calibration is performed, the image 202 can initially be presented without the overlay and without material categories being assigned on the image 202. The initial image 202 can be a greyscale image that merely illustrates portions of the scanned object 204 that are air or are material of the scanned object. This initial image 202 can be referred to as a full image or a phantom image. The initial image can be produced by comparing a signal received by radiation detectors with no scanned object 204 present (e.g., signalₐᵢᵣ) with the signal received by the radiation detectors with the scanned object 102 present (e.g., signal_{object}). The overlay, which can indicate each of the first material 208, the second material 210, the third material 212, the fourth material 214, and the undetermined material 216, can be projected on the image 202 after material discrimination calibration parameters are determined. This overlayed image 202 can be referred to as a material discrimination image.

The image 202 can aid a user in selecting calibration parameters for material discrimination through the material discrimination graph 206 and associated user interface. For example, the user can use the initial image 202 to select, accept, and manage regions of interest (ROIs). The material discrimination graph 206 can display pixels within an ROI selected by the user, while pixels outside the ROI are omitted from the material discrimination graph 206. When an ROI is selected, an ROI image highlighting the ROI can be displayed to the user. The ROI image can include an area of the image 202 encompassed by the ROI. As the user moves a cursor across the image 202, pixels in the material discrimination graph 206 associated with the position of the cursor can be highlighted, and material signature and material thickness data for pixels associated with the position of the cursor can be displayed.

As illustrated in FIG. 2A, when displaying material discrimination results, material discrimination results can be overlaid on the image 202 (e.g., on the full or phantom image or the initial image 202). In FIG. 2A, the image 202 includes material discrimination results of a scanned object 204 overlaid on the initial image 202. In the example of FIG. 2A, the scanned object 204 is a trailer with cargo loaded on a surface thereof. The cargo can include known blocks of materials, which can include both known material types or categories and known material thicknesses. The overlaid image 202 can overlay colors, patterns, or the like over portions of the scanned object 204 (e.g., over the initial image 202 of the scanned object 204) to illustrate what materials and what thicknesses of materials are present in the scanned object 204.

In the example of FIG. 2A, when displaying available material discrimination results, different patterns are used to indicate a first material 208, a second material 210, a third material 212, a fourth material 214, and an undetermined material 216. The first material 208 can indicate light materials, organic materials, or materials having atomic numbers less than 10; the second material 210 can indicate intermediate materials, inorganic materials, or materials having atomic numbers between 10 and 20; the third material 212 can indicate metallic materials or materials having atomic numbers between 20 and 50; the fourth material 214 can indicate heavy metals or materials having atomic numbers greater than 50; and the undetermined material 216 can indicate materials in DMZs, materials outside of the calibration parameters (having material signature ranges between material categories, having thicknesses outside of thickness ranges for material categories, or the like), or the like. Patterns are used for the purposes of this description; however, the materials present in the scanned object 204 can generally be represented by colors rather than patterns. For example, the first material 208 can be represented by orange, the second material 210 can be represented by green, the third material 212 can be represented by blue, the fourth material 214 can be represented by magenta, and the undetermined material 216 can be represented by grey. Different thicknesses of materials can be represented by different shades of a color. For example, darker shades can represent greater thicknesses and lighter shades can represent lower thicknesses. In addition to displaying the overlaid image 202, a display can present material discrimination results overlaid over an ROI image based on the currently selected ROI.

As illustrated in FIG. 2B, the material discrimination graph 206 can include pixels or data points 218 plotted on axes of material signature vs. material thickness. As discussed above, the material signatures can be approximated by K-values and the material thicknesses can be approximated by log 10 of HE attenuation data; however, any suitable approximations for material signatures and material thicknesses can be used.

The material signatures of materials present in the scanned object 204 can vary such that the pixels 218 are grouped together in clusters. Each of the clusters can be representative of and correspond to a region of the scanned object 204. The user can draw dividing lines between the clusters in order to separate the clusters into different material categories.

The scanned object 204 can be a known object, such that the user knows the material categories for materials present in the scanned object 204. The user can identify the material category for each of the clusters of pixels 218 illustrated in the material discrimination graph 206. The user can then establish material discrimination dividing lines to divide or assign the materials represented by the pixels 218 into different material categories. For example, a first material discrimination line 220 can be used to divide materials into the first material 208 and the second material 210; a second material discrimination line 222 can be used to divide materials into the second material 210 and the third material 212; and a third material discrimination line 224 can be used to divide materials into the third material 212 and the fourth material 214. Materials with material signatures (e.g., K-values) greater than the first material discrimination line 220 at a given thickness can be categorized as the first material 208. Materials with material signatures greater than the second material discrimination line 222 and less than the first material discrimination line 220 at a given thickness can be categorized as the second material 210. Materials with material signatures greater than the third material discrimination line 224 and less than the second material discrimination line 222 at a given thickness can be categorized as the third material 212. Materials with material signatures less than the third material discrimination line 224 at a given thickness can be categorized as the fourth material 214.

The first material discrimination line 220, the second material discrimination line 222, and the third material discrimination line 224 can be clear-cut dividing lines (e.g., pixels 218 can be assigned to material categories depending on whether their material signatures are above or below the respective dividing line), or the dividing lines can have thicknesses or buffer zones along the dividing lines. In examples in which the dividing lines have buffer zones or thicknesses, the buffer zones along the dividing lines can be referred to as a demilitarized zone or DMZ. When the pixels 218 fall on the DMZ, no clear-cut material determination is made. The pixels 218 that fall on the discrimination lines 220, 222, 224 can be represented as no material determination made, or by a material determination between the two material categories on either side of the respective discrimination line. For example, for a pixel 218 falling on a discrimination line 220, 222, 224 or within a DMZ, the pixel 218 can be colored grey in the overlaid image 202 or colored with a hue between the two hues of the material categories adjacent to the respective discrimination line 220, 222, 224. In examples in which DMZs are defined along dividing lines 220, 222, 224, pixels 218 whose material signature falls in the DMZs can be illustrated in the overlaid image 202 as a weighted blend of colors representing the material categories adjacent to the material discrimination lines 220, 222, 224. Materials in such pixels 218 cannot be determined with normal or sufficient confidence.

Each of the material discrimination lines 220, 222, 224 can be adjustable by the user during the material discrimination calibration process. As such, the material discrimination lines 220, 222, 224 can be referred to as adjustable boundaries between the material categories. The material discrimination lines 220, 222, 224 can be adjustable at a plurality of thicknesses. For example, the material signature values of the material discrimination lines 220, 222, 224 can be adjustable at eight material thicknesses; however, the material signature values can be adjustable at any number of thicknesses. As the material discrimination lines 220, 222, 224 are adjusted, overlaid material categories illustrated in the ROI image, the overlaid image 202, and the like can be adjusted to reflect the current material discrimination lines 220, 222, 224.

As described in reference to FIG. 2A, a user of the radiation imaging system can select a region of interest, and the material discrimination graph 206 can present pixels 218 that are within the selected ROI while pixels 218 outside the ROI are omitted from the material discrimination graph 206. The user can select the ROI to encompass areas of the scanned object including specific blocks of known materials to aid with drawing or setting specific dividing lines between material categories. This can help the user to select calibration parameters quickly and accurately for dividing lines between material categories, without viewing all the pixels 218 for the entire scan of the scanned object 204.

Further, as the user's cursor moves over the image 202, an ROI image, or the like, the pixels 218 in the material discrimination graph 206 corresponding to the position of the user's cursor can be highlighted and the material signatures and material thicknesses for the pixels 218 corresponding to the position of the user's cursor can be displayed. For example, the material signatures and thicknesses for the pixels 218 corresponding to the cursor position can be displayed in the material discrimination graph 206 (e.g., as a highlighted button). This can also help the user to select calibration parameters quickly and accurately for dividing lines between material categories by correlating the material signatures and material thicknesses to the position of the user's cursor. Such mouse tracking can aid the user in identifying material type or categories of clusters of pixels 218 displayed in the material discrimination graph 206 and can therefore aid the user in adjusting the material discrimination lines 220, 222, 224.

Although FIGS. 2A and 2B are discussed in the context of adjustment of the material discrimination lines 220, 222, 224, any of the calibration parameters can be adjusted to optimize the material discrimination image 202 and the material discrimination graph 206. A display can display the material discrimination image 202, the ROI image, the material discrimination graph 206, and a calibration panel or user interface, which can present calibration parameters and allow for adjustment of the calibration parameters. As any calibration parameters are adjusted, the material discrimination image 202, the ROI image, and the material discrimination graph 206 can be updated in real time. This allows a user to adjust the calibration parameters, immediately see the effect of the adjustment, and continue to refine the calibration parameters. This can reduce the time used to set the calibration parameters and allow more accurate calibration parameters to be determined. The calibration parameters can then be used in subsequent scans to provide more accurate radiation imaging.

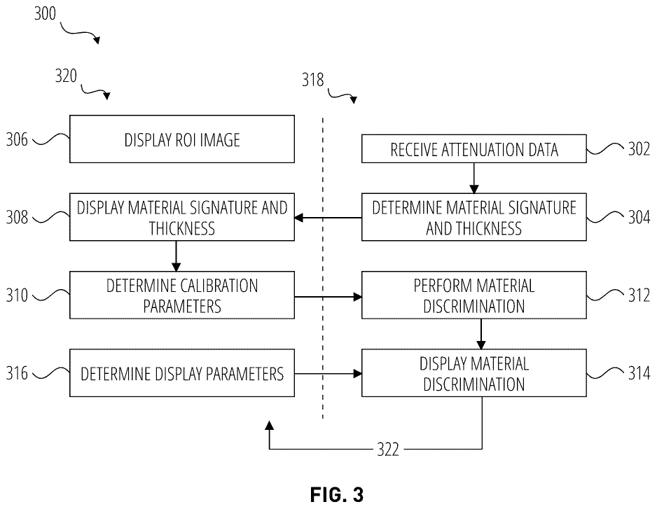

FIG. 3 illustrates a block diagram of a method 300 of calibrating a radiation imaging system. The method 300 can be used to a calibrate radiation imaging system to perform material discrimination and can be used to determine material discrimination calibration parameters. The method 300 can be used to calibrate the radiation imaging system 100 for material discrimination, discussed above with respect to FIG. 1. The method 300 can be used in conjunction with the displays discussed above with reference to FIGS. 2A and 2B, including the image 202 and the material discrimination graph 206. Generally, the method 300 can include presenting material signature and thickness values of pixels to a user (e.g., in a material discrimination graph 206), allowing the user to adjust dividing lines between material categories and adjust other calibration parameters, and applying the material discrimination calibration parameters to generate and display a material discrimination image (e.g., including material categories overlaid on the image 202).

As illustrated in FIG. 3, the method 300 can include a block 302 in which attenuation data is received; a block 304 in which material signatures and thicknesses are determined; a block 306 in which an ROI image is displayed; a block 308 in which the material signatures and thicknesses are displayed; a block 310 in which calibration parameters are determined; a block 312 in which a material discrimination is performed based on the material discrimination calibration parameters; a block 314 in which the material discrimination is displayed; and a block 316 in which display parameters for the material discrimination are determined. The method 300 can be used to determine and adjust calibration parameters and display parameters for material discrimination process, which can be performed with a radiation imaging system (e.g., the radiation imaging system 100). The calibration parameters and the display parameters can be used to generate a material discrimination image, which can include material categories overlaid over an attenuation image, a full image, or a phantom image (e.g., the image 202) and can be saved and used in future radiation imaging scans performed by the radiation imaging system. The method 300 can include steps or blocks that are generally performed by a computing device or system, referred to as system operations 318 and steps or blocks that are generally performed by a user, referred to as user operations 320.

In block 302, attenuation data is received. The attenuation data can be referred to as a data stream, an attenuation data stream, or the like. The attenuation data can be generated based on signals received from radiation detectors, such as the radiation detectors 108. The attenuation data can be generated by exposing a scanned object to x-rays or other radiation generated by a source and detecting attenuated radiation that passes through the scanned object using the radiation detectors. The attenuation data can include both HE attenuation data and LE attenuation data. The attenuation data can be generated from signals received from the radiation detectors 108 based on attenuated x-rays detected by each pixel of the radiation detectors 108. Thus, the attenuation data can correspond to the pixels of the radiation detectors 108 and can correspond to areas of the scanned object through which x-rays pass. In one or all examples, the radiation detectors can be columnar, and two-dimensional attenuation data can be generated by moving a scanned object relative to the radiation detectors. In one or all examples, the radiation detectors can be two-dimensional, and two-dimensional attenuation data can be generated without moving the scanned object relative to the radiation detectors. In one or all examples, the radiation detectors can be two-dimensional, and the scanned object can be moved relative to the radiation detectors in order to scan the entire scanned object. The attenuation data (e.g., the HE attenuation data and the LE attenuation data) can include discrete pixels or data points, which can be correlated to discrete areas in the scanned object. Attenuation data generated based on signals from the radiation detector can be supplied directly to a computing device (e.g., the computing device 110), or can be saved and provided as a file to the computing device.

In block 304, material signatures and thicknesses are determined. The material signatures and thicknesses can be determined for each pixel or data point in the attenuation data. The attenuation data can be supplied or converted into one or more 16-bit data sets, such as a 16-bit data set for the HE attenuation data and a 16-bit data set for the LE attenuation data. However, other formats can be used. A logarithm base 10 can be calculated for each pixel or data point in the HE attenuation data and the LE attenuation data. Various filters can be applied to the attenuation data before or after the logarithm is calculated for each pixel or data point in the HE attenuation data and the LE attenuation data. For example, de-noising filters, median filters, or the like can be applied to the attenuation data. Thus, in block 304, logarithm base 10 data can be calculated for each pixel or data point in the HE attenuation data and the LE attenuation data.

The logarithm base 10 data for the HE attenuation data and the LE attenuation data can be used to calculate a K-value for each pixel or data point in the attenuation data. The K-value for each pixel or data point can be calculated by dividing the logarithm base 10 LE attenuation data for the respective pixel or data point by the logarithm base 10 LE attenuation data for the respective pixel or data point. Various filters can be applied to the attenuation data before or after the K-value is calculated for each pixel or data point in the attenuation data. For example, de-noising filters, median filters, or the like can be applied to the attenuation data. Thus, in block 304, a K-value can be calculated for each pixel or data point in the attenuation data.

In one or all examples, the K-values can be used to represent or approximate material signatures for each of the pixels. The logarithm base 10 data for the HE attenuation data can be used to represent or approximate material thicknesses for each of the pixels. However, any suitable parameters can be used to represent or approximate the material signatures and thicknesses in block 304. For example, the material signatures of the pixels can be represented or approximated based on the raw HE attenuation data and the LE attenuation data (e.g., without performing a logarithm base 10 calculation), based on a natural log of the HE attenuation data and the LE attenuation data, or the like. Similarly, the material thicknesses of the pixels can be represented or approximated based on logarithm base 10 data for the HE attenuation data or the LE attenuation data; natural logarithm data for the HE attenuation data or the LE attenuation data; raw data for the HE attenuation data or the LE attenuation data; or the like.

In block 306, a region of interest (ROI) image is displayed. The ROI image can include a full image or a phantom image for the scanned object and a current ROI image. The full image can be generated based on signals received from the radiation detectors. More specifically, the full image can be generated by comparing a signal received from the radiation detectors with no scanned object present (e.g., signalₐᵢᵣ) with a signal received from the radiation detectors with the scanned object 102 present (e.g., signal_{object}). The full image can be a greyscale image, which can illustrate the difference between material portions of the scanned object and air around the scanned object. The user can select, adjust, or modify an ROI on the full image, and the ROI image can be generated or adjusted accordingly. The ROI can initially be the entire full image, and the user can then select a relatively smaller area of the full image for the ROI image. The ROI image can be displayed as soon as signals for the scanned object are received and can be present or displayed throughout the material discrimination calibration process of the method 300.

In block 308, the material signatures and material thicknesses for each of the pixels determined in block 304 are displayed. The material signatures and material thicknesses can be displayed in a material discrimination graph (e.g., the material discrimination graph 206, discussed above), which can plot a dot or point for each pixel on a graph of material signature vs. material thickness. The material signatures and material thicknesses that are displayed can depend on the ROI selected in block 306. For example, each pixel included within the ROI selected by the user can be displayed on the material discrimination graph, while pixels outside the ROI can be omitted from the material discrimination graph.

The material discrimination graph can be generated by plotting each of the pixels or data points in the attenuation data in a graph that displays material signature (e.g., K-value) vs. material thickness (e.g., logarithm base 10 data for the HE attenuation data). The material discrimination graph can also display material discrimination lines that separate the material categories and are used to assign each of the pixels or data points to a respective material category. The pixels or data points can be grouped into four material categories separated from one another by three material discrimination lines; however, any number of material categories and material discrimination lines can be used.

In block 310, calibration parameters are determined. The calibration parameters can be determined through interactive actions in the material discrimination graph based on the material signatures and thicknesses displayed in block 308. For example, the material signatures and thicknesses within the selected ROI are displayed and presented to the user in block 308. The user can identify clusters of dots, points, or pixels in the material discrimination graph that correspond to known materials (e.g., materials with known material categories and thicknesses). The user can adjust the calibration parameters by adjusting dividing lines between material categories so that the known material categories are correctly assigned. The dividing lines can be represented as material signatures (e.g., K-values) at one or more material thickness points.

A calibration panel, which can include the material discrimination graph or other user interface can be displayed. The calibration panel can provide options for adjusting the calibration parameters. The ROI image and the material discrimination graph can be included in the calibration panel or the user interface. Once calibration parameters are determined and a material discrimination is performed, the calibration panel can further include a material discrimination image, which can include material characteristics (e.g., material category and thickness) overlaid over the full image and/or the ROI image). For example, the calibration panel can display the currently selected calibration parameters and options for adjusting the calibration parameters.

The calibration parameters can include material signatures (e.g., K-values) for each material discrimination dividing line between material categories. The material signatures for each material discrimination dividing line can each be adjustable at a plurality of thickness locations. The material signatures can include single values or ranges of values (e.g., defining bands or DMZs) for each material discrimination dividing line at each thickness location. The determination of whether a single material signature value or a range of material signature values is used at each thickness location for each material discrimination line can also be adjusted. Pixels or data points on or within the material discrimination lines can be assigned to the null or no material determination category or to both adjacent material categories, which can also be adjustable.

The calibration parameters can include thickness ranges for each of the material categories. For example, material signatures can be less accurate for relatively thin materials and for relatively thick materials. As such, a material discrimination determination confidence may be low for relatively thin materials and for relatively thick materials. The user can adjust a thickness range for each of the material categories, depending on desired accuracy and confidence levels. For each material category, a material category can be assigned to a pixel or data point when the material thickness for the pixel or data point is within the thickness range for the material category and no material determination category, a null material category, or an “other” material category can be assigned to the pixel or data point when the material thickness is outside the thickness range for the material category.

The material discrimination graph only presents pixels or data points within the selected region of interest. The user can draw the region of interest (e.g., with a mouse or cursor) within the full image, move edges of a box to define the region of interest, or select a region of interest that includes one or more specific material categories. Since different regions contain different objects (e.g., blocks or groups of materials with various material categories and thicknesses), selecting different regions of interest can help the user identifying material type of each cluster of dots or pixels in the material discrimination graph. This can help the user in drawing proper dividing lines between material categories. Adjusting the ROI can help the user to select proper dividing line values (e.g., material signatures and thicknesses) between material categories, without altering the actual values of the dividing lines.

In one or all examples, the material discrimination lines may be defined as linear lines between discrete material signatures (e.g., K-values) at discrete thickness points in the material discrimination graph. In one or all examples, the material discrimination lines may be defined by higher-order models. Specific material signature values at thickness points can be adjusted or coefficients in higher-order models can be adjusted to alter the material discrimination lines and determine the material discrimination calibration parameters for a radiation imaging system. Further, the material discrimination lines may be defined by singular material signature values at discrete thickness points or ranges of material signature values at the thickness points, such that the material discrimination lines can be lines or bands.

The calibration parameters can further include a beam angle compensation (BAC) parameter. As discussed above, the BAC parameter can be a single parameter that can be adjusted to vary how beam angle is compensated for. The BAC parameter can be used to adjust the material signatures (e.g., K-values) of the material discrimination lines based on the calibration location for the region of interest. For example, material signatures for the material discrimination dividing lines can be increased for locations with smaller beam angles than the calibration location and decreased for locations with larger beam angles than the calibration location. The BAC parameter can be used to compensate for energy variation based on positions of the pixels of the radiation detectors relative to an incident x-ray beam, or the angle between each pixel and a centerline of the incident x-ray beam.

Information for specific pixels or data points can be displayed to a user to aid the user in adjusting the calibration parameters. For example, material signature and material thickness data for one or more pixels at or near a user's cursor can be displayed in the material discrimination graph. This can be referred to as a mouse tracking feature, as the user's mouse or cursor is tracked and data for pixels or data points at or near the user's mouse or cursor are displayed.

Various filters can be used on the data throughout the method 300. For example, the data can be filtered before and/or after blocks 302 and 304. The calibration parameters can include which steps of the method 300 include filtering, what filters are used, and the extent to which filtering is performed.

In block 312, a material discrimination is performed. Performing the material discrimination can include assigning material categories to the pixels based on the material signature and thickness of each pixel and the calibration parameters. The material discrimination can be updated as any of the calibration parameters are adjusted or otherwise updated.

In block 314, the material discrimination is displayed. The material discrimination can be displayed through a material discrimination image. For example, a material discrimination image can be generated by overlaying material discrimination categories (e.g., the material discrimination categories 208, 210, 212, 214, 216) on a full image (e.g., the image 202) of the scanned object. In one or all examples, the calibration parameters and/or the material discrimination graph can be displayed along with the material discrimination image, comparing material signature and thickness of each pixel against material discrimination parameters, primarily dividing lines.

The material discrimination image can be generated by processing an image of the scanned object generated based on signals received from the radiation detectors based on the material discrimination calibration parameters from block 310. Material categories for each pixel can be assigned based on the calibration parameters (e.g., the dividing line material signature and material thickness values from block 310) and data from block 304 (e.g., the pixel-by-pixel material signatures and material thicknesses). Material thicknesses for each pixel or data point in the attenuation data can be assigned based on the calibration parameters and data from block 304 (e.g., the material signatures and material thicknesses).

In one or all examples, blocks 312 and 314 can initially use default calibration parameters, calibration parameters based on calibrations performed on other radiation imaging systems, calibration parameters calculated or proposed by the radiation imaging system, or the like. Blocks 312 and 314 can then use updated calibration parameters as the calibration parameters are adjusted in block 310.

Block 314 can include overlaying colors representing material categories and material thicknesses for each pixel or data point in the attenuation data on the full image or phantom image (e.g., discussed with respect to block 306). As such, an overlaid material discrimination image can be generated and displayed in block 314. Each of the material categories can be associated with a specific color (hue), and darker or lighter colors can indicate relative thicknesses of the materials in the material discrimination image. For example, light materials or organic materials having atomic numbers less than 10 (e.g., the first material 208) can be represented by orange; intermediate materials or inorganic materials having atomic numbers between 10 and 20 (e.g., the second material 210) can be represented by green; metallic materials having atomic numbers between 20 and 50 (e.g., the third material 212) can be represented by blue; heavy metals having atomic numbers greater than 50 (e.g., the fourth material 214) can be represented by magenta; and any other materials, including materials in between material categories, materials with thicknesses outside of ranges prescribed in the calibration parameters, materials in DMZs, and the like (e.g., the undetermined material 216 or no material determination materials) can be represented by grey. Darker colors can indicate greater material thicknesses and lighter colors can indicate lower material thicknesses.

Data points or pixels that are within a small band along the material discrimination lines may be assigned to a null category, a “no material determination” category, an intermediate category between two material categories, or the like. When the data points or pixels are assigned to an intermediate category between two material categories (also referred to as a mixed material category), the data points or pixels can be colored by a hue between the colors of the two material categories adjacent the material discrimination line on which the data points or pixels are located.

In blocks 312 and 314, the material discrimination image and the material discrimination graph can be generated based on default, pre-existing, or calculated calibration parameters. The material discrimination image and the material discrimination graph can be displayed on a display. The display can also display current calibration parameters for the material discrimination image and the material discrimination graph and options for adjusting the calibration parameters.

In block 316, display parameters can be determined. The display parameters can alter how the material discrimination image are displayed on a display. The display parameters can be referred to as color maps or the like. The display parameters can include adjustable hues and adjustable peak color saturations for each of the material categories. The display parameters can include adjustable mapping of color ranges to material thickness ranges. The display parameters can be adjusted and saved during the calibration process for a radiation imaging system and can also be adjustable by a user of the material discrimination calibration system and the method 300. In one or all examples, an end user of the radiation imaging system can adjust the display parameters. In other words, the display parameters can be adjusted at any time, to suit a particular user's wants or needs. The display parameters can be used to make the material discrimination image and/or the material discrimination graph clearer, more aesthetically pleasing, and the like.

As illustrated by the arrow 322, the method 300 can be an iterative method. For example, as a user selects calibration parameters at block 310, the blocks 312 and 314 can be updated in real-time. As the user selects different ROIs at block 306, different pixels can be displayed in the material discrimination graph of block 308. As the user selects different display parameters at block 316, the material discrimination displays of block 314 can be updated in real-time. In one or all examples, material characteristics (e.g., material categories and thicknesses) can be overlaid on an ROI image (e.g., discussed with respect to block 306) during the material discrimination calibration process of method 300, and the material characteristics are not overlaid on a full image (e.g., the image 202 of FIG. 2A) until the calibration parameters are set. This can save processing time during the material discrimination calibration process.

Once the calibration parameters are finalized, the calibration parameters can be saved, and the calibration parameters can be used in subsequent scans performed by the radiation imaging system. The method 300 can be an interactive and iterative process that allows a user to select and optimize the calibration parameters used to perform scans with a radiation imaging system. The method 300 can be used to provide customized results, improved accuracy in calibration parameters, faster calibration, and improved effectiveness for scans using the calibrated radiation imaging system. The method 300 can be used to improve material discrimination performance of a radiation imaging system, correctly determine material categories in larger thickness range, and can be used to provide users with a customized display, including by display adjustable colors and shade for material categories. The method 300 can be a simplified calibration process, which allows for customized beam angle compensation while using a radiation source that emits radiation from a single height or location.

The various blocks 302, 304, 306, 308, 310, 312, 314, 316 can be performed by a computing device (e.g., the computing device 110), by a user, or the like. FIG. 3 illustrates a breakdown of which blocks can be performed by a computing device or system, referred to as system operations 318 and which blocks can be performed by a user, referred to as user operations 320. The system operations 318 can include blocks 302, 304, 312, and 314, and the user operations 320 can include blocks 306, 308, 310, and 316. The method 300 can allow a user to control and adjust the calibration parameters used by a radiation imaging system to perform material discriminations, which can speed up the process of selecting the calibration parameters, require less time and effort on the part of the user, and can produce more accurate calibration parameters. The system operations 318 can include processing, presenting, bookkeeping, and tracking steps, which can reduce the workload on the user in generating the calibration parameters.

In one or more examples, various steps of the method 300 can be performed by artificial intelligence or machine learning. For example, calibration can be performed on one or more radiation imaging systems. The resulting calibration parameters can be input into a machine learning system and used to propose calibration parameters for other radiation imaging systems. The proposed calibration parameters can be used as initial or default calibration parameters in subsequent radiation imaging systems, and the machine learning system can improve the proposed calibration parameters over time as more experimental data and calibration parameters are fed to the machine learning system.

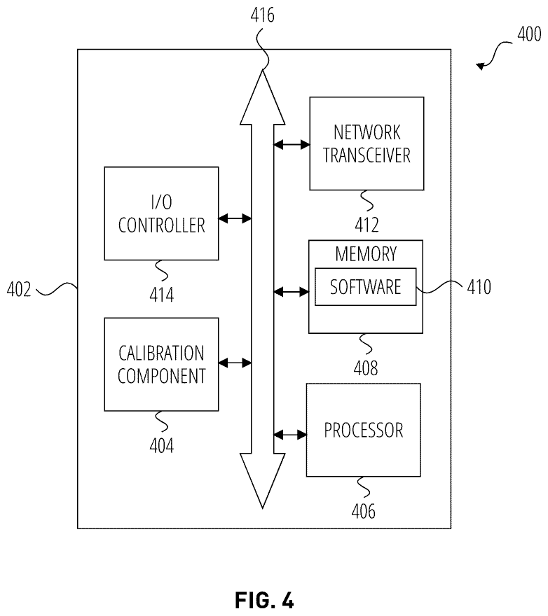

FIG. 4 illustrates a block diagram of a system 400 including a device 402 that supports methods for calibrating radiation imaging systems in accordance with aspects of the present disclosure. The system 400 can be used as the computing device 110 in the radiation imaging system 100, discussed above with respect to FIG. 1; can be used to display the material discrimination image 202 and the material discrimination graph 206, discussed above with respect to FIGS. 2A and 2B; and can perform the method 300, discussed above with respect to FIG. 3. The device 402 may be an example of or include the components of a computer, a computing device, a computing system, or another electronic device. The device 402 may be an example of a portable electronic device, a computer, a laptop computer, a tablet computer, a smartphone, a cellular phone, a wearable device, an internet-connected device, a server, a database, or the like. In one or all examples, the device 402 may be configured for bi-directional wireless communication with other systems or devices using a base station or access point, such as the radiation source 104 and the radiation detectors 108, discussed above with respect to FIG. 1.

The device 402 may include a calibration component 404, a processor 406, a memory 408, software 410, a network transceiver 412, and an I/O controller 414. These components may be in electronic communication with one another via one or more buses (e.g., a bus 416). The device 402 may communicate wirelessly with one or more other devices or computing systems over a network using the network transceiver 412.

The calibration component 404 may implement the functions described with reference to the method 300 of FIG. 3. The calibration component 404 may be implemented in hardware, software executed by the processor 406, firmware, or any combination thereof.

The processor 406 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). The processor 406 may be configured to execute computer-readable instructions stored in a memory to perform various functions (e.g., functions or tasks supporting techniques for performing external and internal inspections on a rotor blade of a wind turbine).

The memory 408 may include random access memory (RAM) and read only memory (ROM). The memory 408 may store computer-readable, computer-executable software 410 including instructions that, when executed, cause the processor to perform various functions described herein. In some cases, the memory 408 may contain, among other things, a BIOS which may control basic hardware or software operation such as the interaction with peripheral components or devices.

The software 410 may include code to implement aspects of the present disclosure, including code to support techniques for calibrating a radiation imaging system. The software 410 may be stored in a non-transitory computer-readable medium such as system memory or other memory. In some cases, the software 410 may not be directly executable by the processor but may cause a computer (e.g., when compiled and executed) to perform functions described herein.

The network transceiver 412 may communicate bi-directionally, via one or more antennas, wired, or wireless links. For example, the network transceiver 412 may represent a wireless transceiver and may communicate bi-directionally with another wireless transceiver. The network transceiver 412 may also include a modem to modulate the packets and provide the modulated packets to the antennas for transmission, and to demodulate packets received from the antennas.

The I/O controller 414 may manage input and output signals for the device 402. The I/O controller 414 may also manage peripherals not integrated into the device 402. In one or all examples, the I/O controller 414 may represent a physical connection or port to an external peripheral. In one or all examples, the I/O controller 414 may utilize an operating system such as iOS®, ANDROID®, MS-DOS®, MS-WINDOWS®, OS/2®, UNIX®, LINUX®, or another known operating system. In one or all examples, the I/O controller 414 may represent or interact with a modem, a keyboard, a mouse, a touchscreen, or a similar device. In one or all examples, the I/O controller 414 may be implemented as part of a processor. In one or all examples, a user may interact with the device 402 via the I/O controller 414 or via hardware components controlled by the I/O controller 414.

The device 402 may receive data from external devices, such as the radiation source 104 and the radiation detectors 108, discussed above with respect to FIG. 1. The data may include attenuation data, which may be derived from signals recorded by the radiation detectors 108. The data may further include x-ray radiation data, such as energy levels of x-ray beams generated by the radiation source 104. The calibration component 404 may analyze the attenuation data, determine material signatures (e.g., K-values) for data points or pixels in the attenuation data, determine material thicknesses for data points or pixels in the attenuation data, and display a material discrimination image and a material discrimination graph based on the attenuation data. The calibration component 404 may further allow a user to adjust calibration parameters and may update the material discrimination image and the material discrimination graph based on the updated calibration parameters. The calibration parameters can be saved in the memory 408 or otherwise saved and can be used as the calibration parameters for future scans using a radiation imaging system.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A non-transitory computer-readable medium storing code for calibrating a radiation imaging system, the code comprising instructions executable by a processor to:
receive a data stream from a radiation detector; and
assign a material category to a pixel based on the data stream and a plurality of calibration parameters, the material category being selected from a plurality of material categories, the plurality of calibration parameters comprising adjustable boundaries between the material categories of the plurality of material categories.

2. The non-transitory computer-readable medium of claim 1, wherein each of the adjustable boundaries comprises a single value above which the pixel is assigned to a first material category and below which the pixel is assigned to a second material category.

3. The non-transitory computer-readable medium of claim 1, wherein each of the adjustable boundaries comprises a range of values above which the pixel is assigned to a first material category, below which the pixel is assigned to a second material category, and between which the pixel is assigned to a mixed material category or a null material category.

4. The non-transitory computer-readable medium of claim 3, wherein the code further comprises instructions executable by the processor to display an image comprising the pixel, wherein the pixel is displayed with a first color when the pixel is assigned to the first material category, a second color when the pixel is assigned to the second material category, or a third color comprising a combination of the first color and the second color when the pixel is assigned to the mixed material category.

5. The non-transitory computer-readable medium of claim 1, wherein the plurality of calibration parameters further comprise a user adjustable thickness range for each material category within which the material category is assigned to the pixel and outside of which no material category is assigned to the pixel.

6. The non-transitory computer-readable medium of claim 1, wherein each of the adjustable boundaries are adjustable at a plurality of thickness locations.

7. The non-transitory computer-readable medium of claim 1, wherein the plurality of calibration parameters further comprises an adjustable beam angle compensation parameter configured to compensate for a position of the pixel in the radiation detector relative to an incident x-ray beam.

8. The non-transitory computer-readable medium of claim 1, wherein the code further comprises instructions executable by the processor to:
select a region of interest from the data stream, the region of interest corresponding to a set of pixels of the radiation detector; and
assign material categories to each pixel in the region of interest based on the data stream and the plurality of calibration parameters.

9. The non-transitory computer-readable medium of claim 1, wherein the code further comprises instructions executable by the processor to use machine learning to propose values for the adjustable boundaries.

10. A method of calibrating a radiation imaging system, the method comprising:
receiving attenuation data from a radiation detector, the attenuation data comprising attenuated x-ray radiation detected at each pixel of a plurality of pixels in the radiation detector;
determining a material signature for each pixel of the plurality of pixels based on the attenuation data;
determining a material category for each pixel of the plurality of pixels based on the material signatures and a plurality of calibration parameters, the plurality of calibration parameters comprising a dividing line value between material categories;
updating the plurality of calibration parameters in response to a user adjusting the dividing line value; and
re-determining the material category for each pixel of the plurality of pixels based on the material signatures and the updated plurality of calibration parameters.

11. The method of claim 10, wherein receiving the attenuation data comprises receiving first attenuation data corresponding to a first scan at a first x-ray energy level and receiving second attenuation data corresponding to a second scan at a second x-ray energy level different from the first x-ray energy level.

12. The method of claim 11, wherein the material signature for each pixel is based on a difference between the first attenuation data and the second attenuation data corresponding to the respective pixel.

13. The method of claim 12, further comprising determining a material thickness for each pixel of the plurality of pixels based on the attenuation data;
wherein the material thickness for each pixel is based on either the first attenuation data or the second attenuation data corresponding to the respective pixel.

14. The method of claim 10, further comprising:
saving the updated plurality of calibration parameters in a memory; and
performing a material discrimination process on an object based on the updated plurality of calibration parameters saved in the memory.

15. The method of claim 10, wherein:
the plurality of calibration parameters further comprises a beam angle compensation value; and
the beam angle compensation value varies the determination of the material category for each pixel of the plurality of pixels based on a relative location of the respective pixel in the radiation detector.

16. A radiation imaging system comprising:
an x-ray detector; and
a processing device coupled to the x-ray detector, the processing device configured to process attenuation data from the x-ray detector and generate a user interface configured to:
present a material discrimination display based on the attenuation data;
receive user instructions to update calibration parameters; and
update the material discrimination display in real-time based on the updated calibration parameters.

17. The radiation imaging system of claim 16, wherein:
the calibration parameters comprise adjustable hues associated with each of a plurality of material categories; and
the material discrimination display assigns one of the plurality of material categories to each of a plurality of pixels.

18. The radiation imaging system of claim 16, wherein:
the attenuation data comprises a beam angle for each of a plurality of pixels of the x-ray detector; and
the material discrimination display assigns one of a plurality of material categories to each of the plurality of pixels based on the respective beam angle.

19. The radiation imaging system of claim 16, wherein the calibration parameters comprise user-adjustable values that separate the attenuation data into a plurality of material categories.

20. The radiation imaging system of claim 16, wherein the user interface is further configured to present the material discrimination display based on a user-adjustable region of interest.
